(19) United States
(12) Patent Application Publication
(10) Pub. No.: US 2007/0184367 A1
(43) Pub. Date: Aug. 9, 2007

(54) Liquid crystal display device and manufacturing method thereof

(76) Inventors: In Woo Kim, Yongin-si (KR); Nam Seok Lee, Suwon-si (KR); Young goo Song, Suwon-si (KR); Woo Sung Sohn, Seoul (KR); Min Hyung Choo, Asan-si (KR); Kyung Suk Jung, Iksan-si (KR)

Correspondence Address: CANTOR COLBURN, LLP, 55 GRIFFIN ROAD SOUTH, BLOOMFIELD, CT, 06002, US

(21) Appl. No.: 11/515,071

(22) Filed: Sep. 1, 2006

(30) Foreign Application Priority Data
Feb. 6, 2006 (KR) 2006-0011109

(51) Int. Cl. G02F 1/03; G02F 1/1333; G02F 1/1339

(52) U.S. Cl. 430/20; 349/155; 349/160

(57) ABSTRACT

An exemplary liquid crystal display (“LCD”) device and a manufacturing method thereof are capable of improving a drop margin of liquid crystal. The LCD device according to an exemplary embodiment of the present invention include first and second substrates that are assembled with liquid crystal disposed therebetween, an organic layer formed on one of the first and second substrates, a column spacer formed between the first and second substrates, and a buffering pattern formed in the organic layer at a region in which the column spacer and the organic layer are in contact with each other.

This application claims priority to Korean Patent Application No. 2006-0011109, filed on Feb. 6, 2006, and all the benefits accruing therefrom under 35 U.S.C. §119, and the contents of which in its entirety are hereby incorporated by reference.

### BACKGROUND OF THE INVENTION

1. Field of the Invention

The present invention relates generally to a liquid crystal display (“LCD”) device, and more particularly, to an LCD device and a manufacturing method thereof, capable of improving a drop margin of liquid crystal.

2. Description of the Related Art

An LCD device controls light transmittance of liquid crystal having dielectric anisotropy by using an electric field, thereby displaying an image. The LCD device is formed by assembling an upper substrate on which a color filter array is formed and a lower substrate on which a thin film transistor (“TFT”) array is formed, with liquid crystal disposed therebetween. A cell gap into which the liquid crystal is filled is maintained by a column spacer formed between the upper and lower substrates.

The column spacer is mainly applied to a large-sized LCD device in which a liquid crystal layer is formed by a one drop filling (“ODF”) technique. The column spacer determines a drop margin of the liquid crystal. Namely, the drop margin of the liquid crystal is improved as the amount of compressive strain of the column spacer is increased. Therefore, a method has been proposed for raising the amount of compressive strain of the column spacer by controlling the material, size and density thereof.

However, the method for raising the drop margin by the amount of compressive strain has limitations. For example, if the amount of compressive strain of the column spacer is increased, the column spacer or its underlying layer may break. Then it is difficult to control the drop amount of the liquid crystal due to a decrease in the drop margin and thus a defect occurs such as an excess or shortage of the liquid crystal. If there is an excess of liquid crystal, the column spacer formed on the upper substrate does not contact the lower substrate and the liquid crystal flows by gravity, thereby causing a luminance defect due to unevenness of the cell gap. If there is a shortage of liquid crystal, light leakage occurs through a space into which the liquid crystal is not filled.

### BRIEF SUMMARY OF THE INVENTION

It is therefore an aspect of the present invention to provide an LCD device and a manufacturing method thereof, capable of improving a drop margin of liquid crystal.

In order to achieve the above and other aspects of the invention, an LCD device according to an exemplary embodiment of the present invention includes first and second substrates assembled with liquid crystal disposed therebetween, an organic layer formed on one of the first and second substrates, a column spacer formed between the first and second substrates, and a buffering pattern formed in the organic layer at a region in which the column spacer and the organic layer are in contact with each other. The LCD device further includes an outer groove or hole formed on the organic layer along the periphery of the buffering pattern to provide the buffering pattern.

The outer groove or hole is formed to encompass the buffering pattern or partially formed around the buffering pattern. The LCD device further includes an internal groove or hole formed within the buffering pattern of the organic layer. The internal groove or hole is independently formed within the buffering pattern or is connected to the outer groove or hole.

The LCD device further includes a transparent conductive layer formed on the organic layer, and a hole penetrating the transparent conductive layer between the column spacer and the buffering pattern of the organic layer so that the transparent conductive layer does not exist therebetween.

The LCD device further includes a TFT formed between the first substrate and the organic layer, a gate line and a data line that are formed between the first substrate and the organic layer and connected to the TFT, and a pixel electrode formed of the transparent conductive layer on the organic layer and connected to the TFT through a contact hole penetrating the organic layer. The LCD device further includes a shield common line formed of the transparent conductive layer on the organic layer so as to overlap at least one of the gate line and the data line. The LCD device further includes an inorganic layer formed between the TFT and the organic layer.

According to another exemplary embodiment of the present invention, a method of manufacturing an LCD device includes providing a first substrate and a second substrate, forming an organic layer on one of the first and second substrates, forming column spacer between the first and second substrates, assembling the first and second substrates with liquid crystal disposed therebetween, and forming a buffering pattern in the organic layer at a region of the organic layer that is to be in contact with the column spacer. An outer groove or hole is formed in the organic layer along the periphery of the buffering pattern, and the outer groove of the organic layer is formed by using a diffraction exposure mask or a half-tone mask.

### BRIEF DESCRIPTION OF THE DRAWINGS

The above and other aspects, features and advantages of the present invention will become more apparent from the following detailed description when taken in conjunction with the accompanying drawings in which:

FIGS. 1A and 1B are cross-sectional views illustrating an LCD device before and after pressure is applied thereon, respectively, according to an exemplary embodiment of the present invention;

FIG. 2 is a cross-sectional view illustrating an LCD device according to another exemplary embodiment of the present invention;

FIGS. 3A to 3E are top plan views illustrating various types of organic layer grooves according to an exemplary embodiment of the present invention;

FIG. 4 is a top plan view illustrating a structure of one subpixel in a TFT substrate of an LCD device according to an exemplary embodiment of the present invention;

FIG. 5 is a cross-sectional view illustrating, together with a color filter substrate, the TFT substrate taken along line V-V′ shown in FIG. 4; and

FIG. 6 is a cross-sectional view for describing a method of manufacturing the organic insulating layer shown in FIG. 5.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

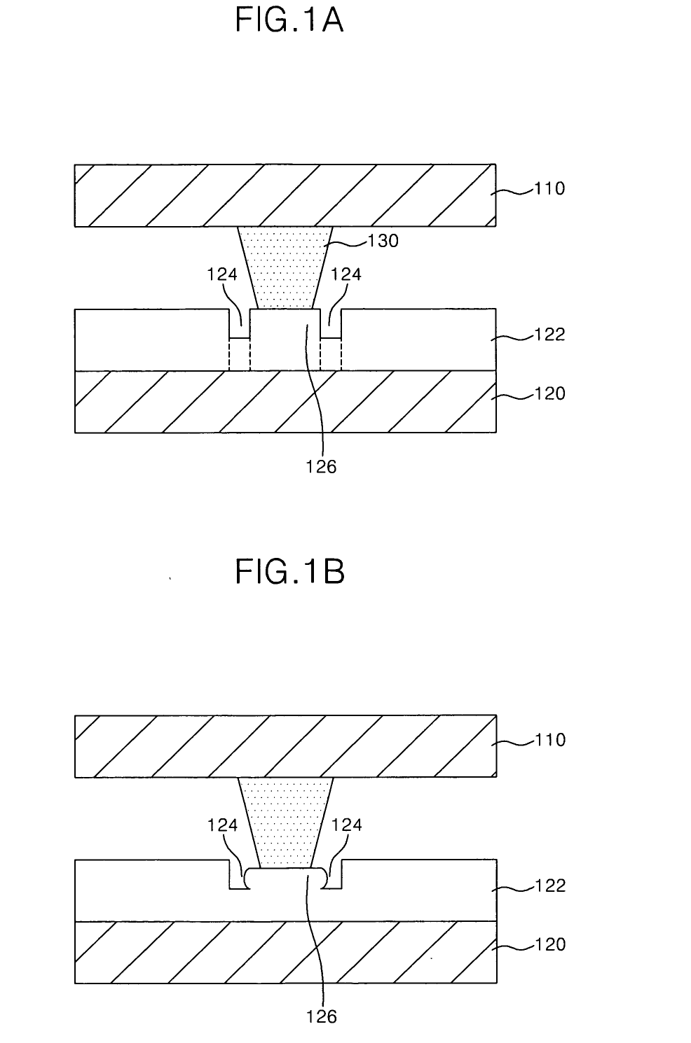

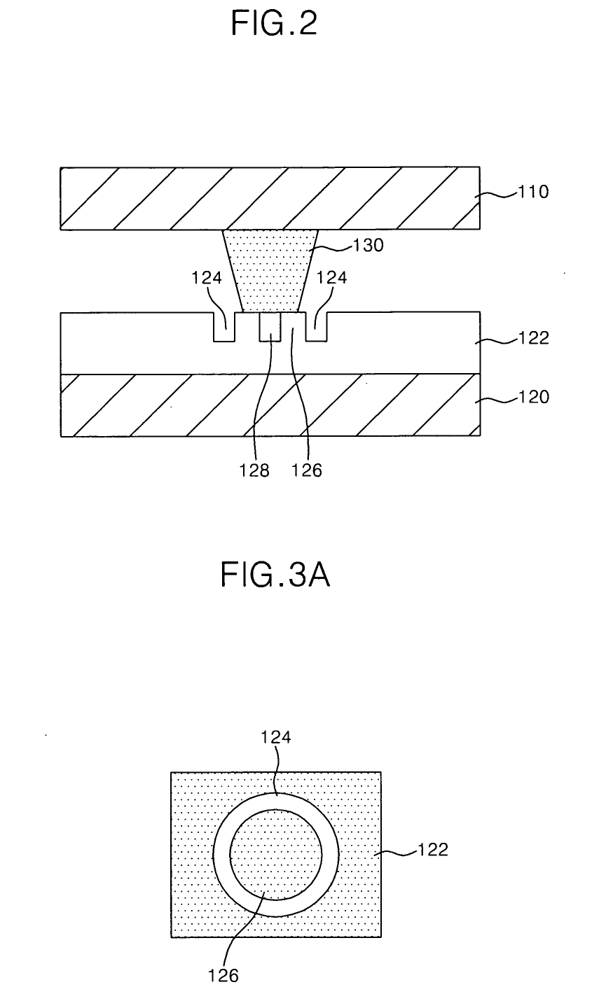

FIGS. 1A and 1B are cross-sectional views illustrating an LCD device centering around a column spacer, before and after pressure is applied thereon, respectively, according to an exemplary embodiment of the present invention. FIG. 2 is a cross-sectional view illustrating an LCD device centering around a column spacer according to another exemplary embodiment of the present invention.

The LCD device shown in FIGS. 1 and 2 includes upper and lower substrates 110 and 120 assembled with a liquid crystal layer (not shown) disposed therebetween, and a column spacer 130 formed between the upper and lower substrates 110 and 120.

The upper substrate 110 includes a color filter array formed on an insulating layer. The lower substrate 120 includes a TFT array formed on an insulating layer and an organic insulating layer 122 covering the TFT array. The column spacer 130 is formed between the upper and lower substrates 110 and 120 to provide a cell gap therebetween. The liquid crystal layer is formed within the cell gap.

A buffering pattern 126 capable of absorbing pressure of the column spacer 130 is formed at a region of the organic insulating layer 122 contacting the column spacer 130. The buffering pattern 126 is formed in the insulating layer 122 and provided by forming an outer groove 124 around the region of the organic insulating layer 122 contacting the column spacer 130. Alternatively, the outer groove 124 of the organic insulating layer 122 may be formed in an outer hole shape by being extended to penetrate an entire thickness of the organic insulating layer 122 as indicated by dotted lines in FIG. 1A. The outer groove (or hole) 124 of the organic insulating layer 122 is formed to encompass the entire periphery of the buffering pattern 126 or partially formed around the buffering pattern 126. As shown in FIG. 2, an internal groove (or hole) 128 may be additionally formed within the buffering pattern 126 of the organic insulating layer 122 contacting the column spacer 130.

If pressure is applied through the column spacer 130, the buffering pattern 126 of the organic insulating layer 122 is compressed and strained as shown in FIG. 1B, thereby absorbing the pressure. As a result, a drop margin caused by the strain of the buffering pattern 126 is added to that caused by the amount of strain of the column spacer 130, thereby increasing the drop margin of liquid crystal. In other words, when a sealant is deposited and the upper and lower substrates 110 and 120 are heated and pressed after the liquid crystal is dropped onto the upper or lower substrate 110 or 120, the buffering pattern 126 of the organic insulating layer 122 is strained together with the column spacer 130. Therefore, a drop margin of the liquid crystal can be sufficiently ensured during an ODF process.

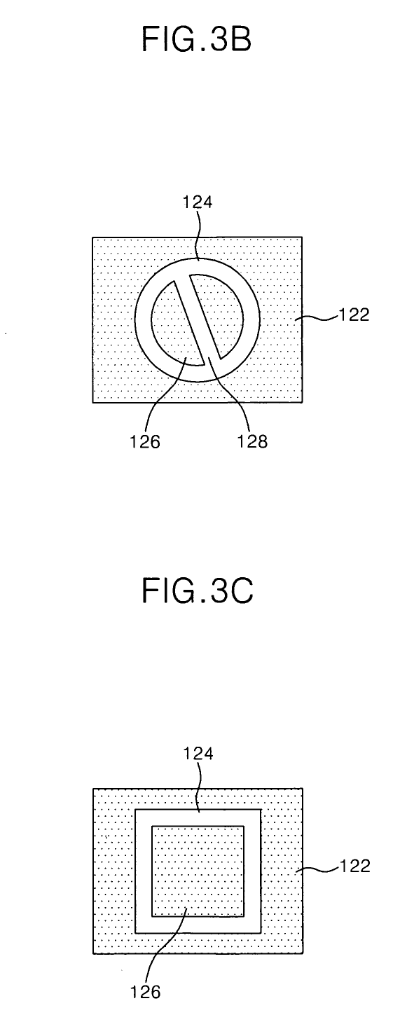

The buffering pattern 126 and outer groove (or hole) 124 of the organic insulating layer 122 are not limited to a particular shape, as they may be formed in various shapes as shown in FIGS. 3A to 3E. For example, the outer groove (or hole) 124 in a circular band shape may be formed at the organic insulating layer 122 to form the buffering pattern 126 of a round shape as shown in FIG. 3A, or alternatively, the internal groove (or hole) 128 may be formed within the buffering pattern 126 of a circle shape as shown in FIG. 3B. The internal groove (or hole) 128 may be connected to the outer groove (or hole) 124 as shown in FIG. 3B, or it may be independently formed within the buffering pattern 126. Meanwhile, the outer groove (or hole) 124 may be partially formed around the buffering pattern 126 of the organic insulating layer 122 as shown in FIG. 3E. The outer groove (or hole) 124 in a rectangular (or polygonal) band shape may be formed to form the buffering pattern 126 of a rectangular (or polygonal) shape as shown in FIG. 3C, or the internal groove (or hole) 128 may be additionally formed within the buffering pattern 126 of a rectangular (or polygonal) shape as shown in FIG. 3D.

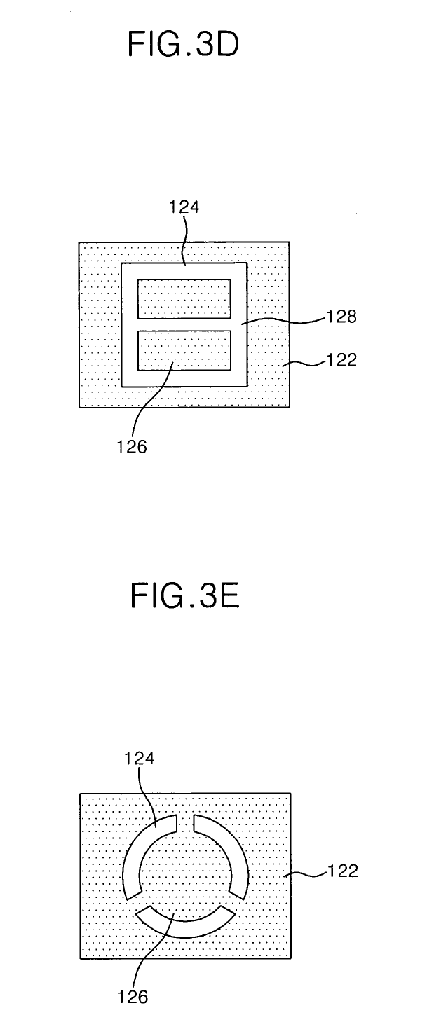

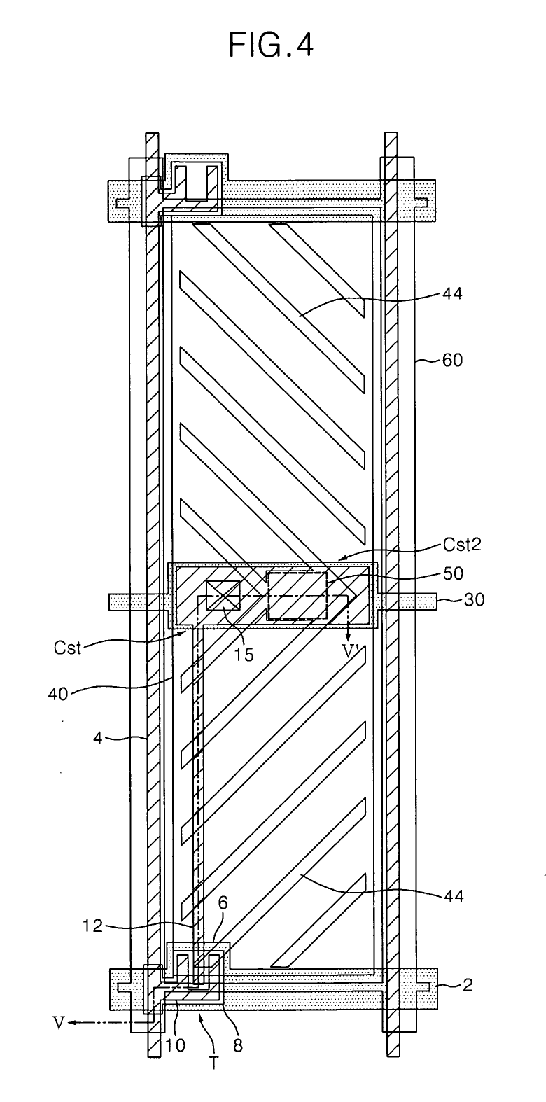

FIG. 4 is a top plan view illustrating a structure of one subpixel in a TFT substrate of an LCD device according to an exemplary embodiment of the present invention. FIG. 5 is a cross-sectional view illustrating, together with a color filter substrate, the TFT substrate taken along line V-V′ shown in FIG. 4.

The TFT substrate shown in FIGS. 4 and 5 includes a pixel electrode 40 formed in a subpixel region defined by an intersection of a gate line 2 and a data line 4, a TFT T connected between the gate and data lines 2 and 4 and the pixel electrode 40, and an organic insulating layer 74 formed between the TFT T and the pixel electrode 40.

The gate line 2 and the data line 4 are formed on an insulating substrate 70 to cross each other with a gate insulating layer 72 disposed therebetween. Each subpixel region is defined by the crossing structure of the gate line 2 and the data line 4. A storage line 30 is formed on the insulating substrate 70 in parallel with the gate line 2. The storage line 30 passes through the center of each subpixel in a short side direction thereof and crosses the data line 4 with the gate insulating layer 72 disposed therebetween.

The TFT T includes a gate electrode 6 connected to the gate line 2, a source electrode 10 connected to the data line 4, a drain electrode 12 connected to the pixel electrode 40, and a semiconductor layer 8 connected to the source electrode 10 and to the drain electrode 12. The semiconductor layer 8 includes an active layer 8A forming a channel between the source electrode 10 and the drain electrode 12, and an ohmic contact layer 8B for an ohmic contact between the active layer 8A and the source and drain electrodes 10 and 12.

The pixel electrode 40 is formed on the organic insulating layer 74 covering the TFT T and connected to the drain electrode 12 of the TFT T through a contact hole 15 penetrating the organic insulating layer 74. The drain electrode 12 of the TFT T extends to the center of the subpixel in which the storage line 30 is formed and connects to the pixel electrode 40 through the contact hole 15 overlapping the storage line 30. Moreover, the drain electrode 12 overlaps the storage line 30 with the gate insulating layer 72 disposed therebetween, thereby forming a storage capacitor Cst. An inorganic insulating layer 78 may be additionally formed under the organic insulating layer 74 and at this time the contact hole 15 is formed by penetrating the inorganic insulating layer 78. A shield common line 60 overlapping the data line 4 and gate line 2 is formed on the organic insulating layer 74. The shield common line 60 has a line width wider than that of the data line 4 and narrower than that of the gate line 2. A common voltage identical to or similar to a voltage supplied to a common electrode 86 of the color filter substrate is applied to the shield common line 60. Then no electric field is formed or a weak electric field is formed between the shield common line 60 and the common electrode 86 of the color filter substrate, and vertically aligned (“VA”) liquid crystal molecules are not driven therebetween, thereby preventing light leakage.

Slits 44 for forming a multi-domain are formed in the pixel electrode 40. The slits 44 of the pixel electrode 40 are formed in a slanted direction symmetrically relative to a short side direction of the subpixel, i.e., on the basis of the storage line 30. The slits 44 of the pixel electrode 40 form a fringe field between the pixel electrode 40 and the common electrode 86 of the color filter substrate to cause liquid crystal molecules to be symmetrically aligned on the basis of the slits 44, thereby forming the multi-domain. To form more domains, common electrode slits (not shown) may be formed in parallel in the common electrode 86 of the color filter substrate in a staggering structure with respect to the slits 44 of the pixel electrode 40. The color filter substrate shown in FIG. 5 includes a black matrix 82, a color filter 84 and the common electrode 86 that are sequentially formed on an insulating substrate 80. An overcoat layer may be formed between the color filter 84 and the common electrode 86. A column spacer 50 is formed on the color filter substrate. Generally, the column spacer 50 overlaps the storage line 30 of the TFT substrate.

A buffering pattern 75 capable of absorbing pressure of the column spacer 50 is formed at a region of the organic insulating layer 74 of the TFT substrate contacting the column spacer 50. The buffering pattern 75 is provided by forming an outer groove 76 at the periphery of the organic insulating layer 74 contacting the column spacer 50. The outer groove 76 of the organic insulating layer 74 may be formed in an outer hole shape and extend to penetrate an entire thickness of the organic insulating layer 74 as indicated by dotted lines. The outer groove (or hole) 76 of the organic insulating layer 74 is formed to encompass all the periphery of the buffering pattern 75 or partially formed around the buffering pattern 75. Moreover, an internal groove (or hole) may be formed within the buffering pattern 75 of the organic insulating layer 74 contacting the column spacer 50. Hence, if pressure is applied through the column spacer 50, the buffering pattern 75 is compressed and strained, thereby absorbing the pressure. Consequently, a drop margin of the liquid crystal caused by the strain of the buffering pattern 75 is added to that caused by the amount of strain of the column spacer 50, thereby increasing the drop margin. In other words, when a sealant is deposited and the color filter substrate and the TFT substrate are heated and pressed after the liquid crystal is dropped onto the color filter substrate or the TFT substrate, the buffering pattern 75 of the organic insulating layer 74 is strained together with the column spacer 50. Therefore, the drop margin can be sufficiently ensured during an ODF process of the liquid crystal.

Meanwhile, if a transparent conductive layer, e.g., an inorganic layer, exits between the column spacer 50 and the buffering pattern 75 of the organic insulating layer 74, the pixel electrode 40 may be damaged by pressure applied from the column spacer 50, and therefore, the transparent conductive layer is not formed on the buffering pattern 75. For example, if the column spacer 50 is formed at a part overlapping the storage line 30 as shown in FIGS. 4 and 5, a hole for penetrating the pixel electrode 40 corresponding to the buffering pattern 75 is formed so that the pixel electrode 40 does not exist between the buffering pattern 75 of the organic insulating layer 74 and the column spacer 50. If the column spacer 50 is formed at a part overlapping the gate line 2 or the data line 4, a hole for penetrating the shield common line 60 corresponding to the buffering pattern 75 is formed so that the shield common line 60 does not exist between the buffering pattern 75 of the organic insulating layer 74 and the column spacer 50. Therefore, the transparent conductive layer can be prevented from being damaged when the column spacer 50 and the buffering pattern 75 of the organic insulating layer 74 are strained by the heat and compression of the color filter substrate and the TFT substrate or by the weight applied to the color filter substrate.

A method of manufacturing the TFT substrate shown in FIGS. 4 and 5 will now be described hereinbelow.

A gate metal pattern, including the gate line 2, the gate electrode 6 connected to the gate line 2, and the storage line 30 parallel with the gate line 2, is formed on the lower insulating substrate 70 by a first mask process. By a second mask process, the gate insulating layer 72 is formed on the lower insulating substrate 70 on which the gate metal pattern is formed, and the semiconductor layer 8, including the active layer 8A and the ohmic contact layer 8B, is formed on the gate insulating layer 72 so as to overlap a part of the gate line 2 and the gate electrode 6. A source/drain metal pattern, including the data line 4, the source electrode 10 and the drain electrode 12, is formed by a third mask process on the gate insulating layer 72 on which the semiconductor layer 8 is formed. The semiconductor layer 8 and the source/drain metal pattern may be formed by one mask process using a diffraction exposure mask or a half-tone mask.

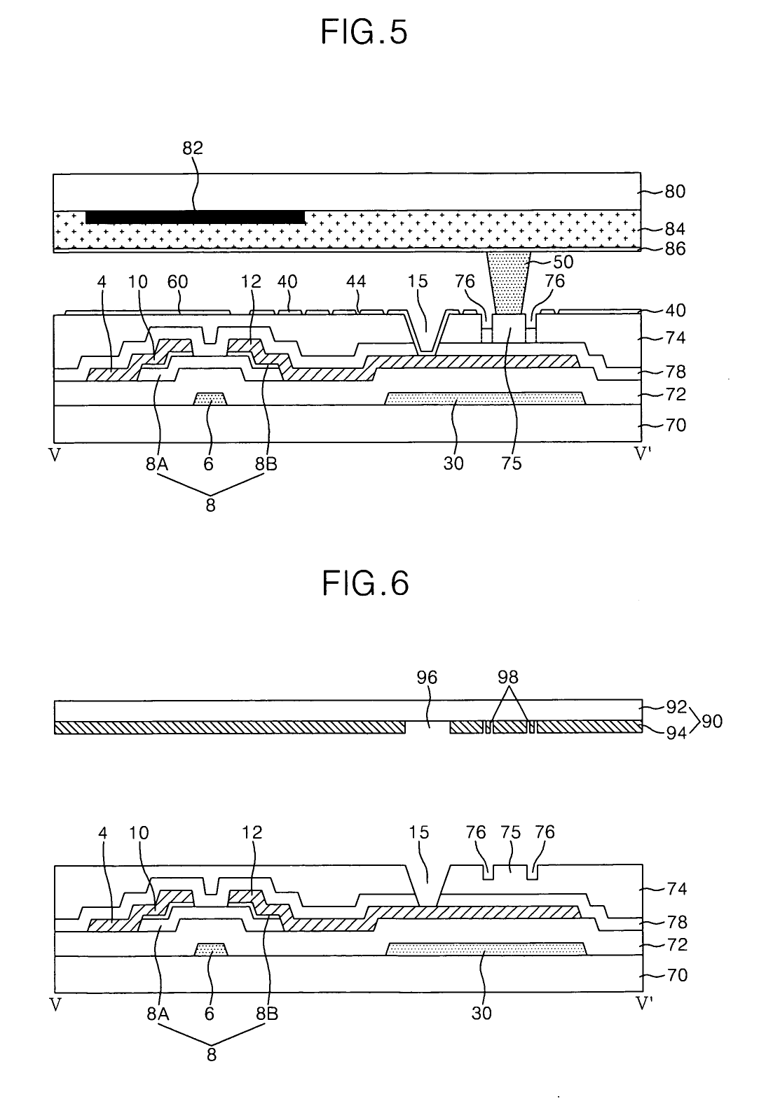

By a fourth mask process, the inorganic insulating layer 78 and the organic insulating layer 74 are formed on the gate insulating layer 72 on which the source/drain metal pattern is formed, and the contact hole 15 and the outer groove (or hole) 76 are formed. Specifically, as shown in FIG. 6, the inorganic insulating layer 78 and the organic insulating layer 74 are deposited on the gate insulating layer 72 on which the source/drain metal pattern is formed by the fourth mask process and the organic insulating layer 74 and the inorganic insulating layer 78 are patterned by a photolithographic process using a mask 90. A diffraction exposure mask or a half-tone mask is used as the mask 90. If the diffraction exposure mask is used, the organic insulating layer 74 and the inorganic insulating layer 78 exist in an opaque region corresponding to an opaque part 94 formed on a mask substrate 92, and the contact hole 15 penetrating the organic insulating layer 74 and the inorganic insulating layer 78 is formed in a full transmission region corresponding to a transmission part 96 in which the mask substrate 92 is exposed. A part of the organic insulating layer 74 is etched or the outer groove (or hole) 76 penetrating the organic insulating layer 74 is formed in a semi-transmission region corresponding to a diffraction exposing part in which a plurality of slits 98 penetrating the opaque part 94 is formed, thereby forming the buffering pattern 75 of the organic insulating layer 74.

Next, a transparent conductive pattern including the pixel electrode 40 and the shield common line 60 are formed on the organic insulating layer 74 by a fifth mask process.

As described above, the LCD device and the manufacturing method thereof according to the present invention form the buffering pattern that is separately formed on the organic insulating layer contacting the column spacer by the outer groove (or hole) and is compressed and strained together with the column spacer. Therefore, the drop margin of the liquid crystal caused by the strain of the buffering pattern is added to that caused by the amount of strain of the column spacer, thereby increasing the drop margin. Since the drop margin of the liquid crystal can be sufficiently ensured, a defect of picture quality caused by a defect of the drop margin can be prevented.

While the invention has been shown and described with reference to certain exemplary embodiments thereof, it will be understood by those skilled in the art that various changes in form and details may be made therein without departing from the spirit and scope of the present invention as defined by the appended claims.

What is claimed is:

1. A liquid crystal display device, comprising:
first and second substrates assembled with liquid crystal disposed therebetween;
an organic layer formed on one of the first and second substrates;
a column spacer formed between the first and second substrates; and
a buffering pattern formed in the organic layer at a region in which the column spacer and the organic layer are in contact with each other.

2. The liquid crystal display device according to claim 1, wherein the buffering pattern is defined by a groove or hole formed in the organic layer.

3. The liquid crystal display device according to claim 2, further comprising an internal groove or hole formed within the buffering pattern of the organic layer.

4. The liquid crystal display device according to claim 3, wherein the internal groove or hole is independently formed within the buffering pattern or is connected to the groove or hole.

5. The liquid crystal display device according to claim 2, further comprising:
a transparent conductive layer formed on the organic layer; and
a hole penetrating the transparent conductive layer between the column spacer and the buffering pattern of the organic layer so that the transparent conductive layer does not exist therebetween.

6. The liquid crystal display device according to claim 5, further comprising:
a thin film transistor formed between the first substrate and the organic layer;
a gate line and a data line formed between the first substrate and the organic layer and connected to the thin film transistor; and
a pixel electrode formed of the transparent conductive layer on the organic layer and connected to the thin film transistor through a contact hole penetrating the organic layer.

7. The liquid crystal display device according to claim 6, further comprising a shield common line formed of the transparent conductive layer on the organic layer, the shield common line overlapping at least one of the gate line and the data line.

8. The liquid crystal display device according to claim 6, further comprising an inorganic layer formed between the thin film transistor and the organic layer.

9. The liquid crystal display device according to claim 1, wherein the buffering pattern is compressed by the column spacer, and a surface of the buffering pattern contacting the column spacer is not coplanar with an uppermost surface of a remainder of the organic layer facing the second substrate.

10. A method of manufacturing a liquid crystal display device, the method comprising:
providing a first substrate and second substrate;
forming an organic layer on one of the first and second substrates;
forming a column spacer on one of the first and second substrates;
assembling the first and second substrates with liquid crystal disposed therebetween; and
forming a buffering pattern in the organic layer at a region of the organic layer that is to be in contact with the column spacer.

11. The method according to claim 10, wherein a groove or hole is formed in the organic layer and defines the buffering pattern.

12. The method according to claim 11, wherein an internal groove or hole is further formed within the buffering pattern of the organic layer.

13. The method according to claim 12, wherein the internal groove or hole is independently formed within the buffering pattern or is connected to the outer groove or hole.

14. The method according to claim 11, further comprising:
forming a transparent conductive layer on the organic layer; and
forming a hole penetrating the transparent conductive layer between the column spacer and the buffering pattern of the organic layer so that the transparent conductive layer does not exist therebetween.

15. The method according to claim 14, further comprising:
forming a thin film transistor between the first substrate and the organic layer, and a gate line and a data line that are connected to the thin film transistor;
forming a contact hole penetrating the organic layer; and
forming a pixel electrode made of the transparent conductive layer on the organic layer and connected to the thin film transistor through the contact hole.

16. The method according to claim 15, further comprising forming a shield common line made of the transparent conductive layer on the organic layer overlapping at least one of the gate line and the data line.

17. The method according to claim 15, further comprising forming an inorganic layer between the thin film transistor and the organic layer.

18. The method according to claim 15, wherein the contact hole and the groove of the organic layer are formed by using a diffraction exposure mask or a half-tone mask.

19. The method according to claim 16, wherein the contact hole and the groove of the organic layer are formed by using a diffraction exposure mask or a half-tone mask.

20. The method according to claim 10, further comprising compressing the buffering pattern with the column spacer, wherein a surface of the buffering pattern in a compressed state is not coplanar with an uppermost surface of a remainder of the organic layer facing the second substrate.
